(19) United States
(12) Patent Application Publication
(10) Pub. No.: US 2019/0265434 A1
(43) Pub. Date: Aug. 29, 2019

(54) LENS BARREL

(71) Applicant: CANON KABUSHIKI KAISHA, Tokyo (JP)

(72) Inventor: Hiroyuki Hase, Fujisawa-shi (JP)

(21) Appl. No.: 16/286,339

(22) Filed: Feb. 26, 2019

(30) Foreign Application Priority Data
Feb. 28, 2018 (JP) 2018-035317

(51) Int. Cl. G02B 7/16; H04N 5/225

(52) U.S. Cl. CPC G02B 7/16; H04N 5/2254

(57) ABSTRACT

A lens barrel in which a depth of a cam groove at an intersecting portion where the cam groove and a straight groove intersect with each other can be increased and an amount of engagement of each cam pin can be ensured while an increase in the size of the lens barrel and deterioration in engagement operability are prevented. Cam grooves on an inner peripheral surface of a drive member are formed at different height positions in an optical axis direction so that straight pins that engage with straight grooves pass through intersecting portions at different timings.

### BACKGROUND OF THE DISCLOSURE

### Field of the Disclosure

The disclosure relates to a lens barrel, and more particularly, to a lens barrel used for an image capturing apparatus, such as a digital camera which includes a zoom function.

### Description of the Related Art

A cam mechanism is known as a means to cause a lens support frame to move along an optical axis. The can mechanism has a structure in which, for example, three cam shafts are provided on an outer peripheral surface of a lens support frame and the cam shafts penetrate through three straight holes of a fixed barrel and engage with three cam grooves of a rotation barrel.

A structure in which a rotation barrel is rotated to cause a lens support frame to move by an amount corresponding to a displacement of each cam groove along the optical axis is known.

Japanese Patent Application Laid-open No. 2001-235672 discusses a structure in which the depth of a straight groove formed on an inner peripheral surface of a barrel body is set to be smaller than the depth of a cam groove, and the cam groove at an intersecting portion where the straight groove and the cam groove intersect with each other is formed at a depth equal to the depth of the straight groove.

However, in the structure discussed in Japanese Patent Application Laid-open No. 2001-235672, the depth of the cam groove at the intersecting portion where the cam groove and the straight groove intersect with each other is small.

Accordingly, there is an issue that the cam shaft (cam pin) is disengaged from the cam groove and moves to the straight groove when the cam shaft (cam pin) to engage with the cam groove passes through the intersecting portion.

To ensure a sufficient depth of the cam groove at the intersecting portion, the depth of the cam groove can be increased by increasing the outer diameter of the barrel body. However, this causes an issue that the size of a barrel is increased.

Moreover, to ensure a sufficient depth of the cam groove at the intersecting portion, the depth of the straight groove at the intersecting portion can be reduced. However, this causes an issue that the engagement operability of the barrel body deteriorates.

### SUMMARY OF THE DISCLOSURE

The disclosure has been made in view of the above-described issues and is directed to providing a lens barrel that prevents an increase in the size of the barrel and deterioration in engagement operability.

More specifically, the disclosure is directed to providing a lens barrel in which the depth of a cam groove at an intersecting portion where the cam groove and a straight groove intersect with each other can be increased and a desired amount of engagement of each cam shaft (cam pin) can be ensured.

According to an aspect of the disclosure, a lens barrel includes a first barrel including a first cam groove, a second cam groove, a first straight groove extending along an optical axis direction, and a second straight groove extending along the optical axis direction, the first cam groove, the second cam groove, the first straight groove, and the second straight groove being formed on a same plane of the first barrel, a first cam pin configured to engage with the first cam groove, a second cam pin configured to engage with the second cam groove, a first straight pin configured to engage with the first straight groove, and a second straight pin configured to engage with the second straight groove. The first barrel is provided with a first intersecting portion where the first cam groove intersects with the first straight groove, and a second intersecting portion where the second cam groove intersects with the second straight groove. A depth of the first straight groove at the first intersecting portion is smaller than a depth of the first straight groove at a portion other than the first intersecting portion. A depth of the second straight groove at the second intersecting portion is smaller than a depth of the second straight groove at a portion other than the second intersecting portion. Timing when the first straight pin configured to engage with the first straight groove passes through the first intersecting portion is different from timing when the second straight pin configured to engage with the second straight groove passes through the second intersecting portion.

Further features and aspects of the disclosure will become apparent from the following description of example embodiments with reference to the attached drawings.

### BRIEF DESCRIPTION OF THE DRAWINGS

FIG. 1 is an exploded perspective view illustrating an internal structure of components supported by a rotation barrel according to a first example embodiment.

FIG. 2 is a developed view of an outer surface of the rotation barrel according to the first example embodiment.

FIG. 3 is an exploded perspective view illustrating an internal structure of components supported by a fixed barrel according to the first example embodiment.

FIGS. 4A and 4B are side views each illustrating a fourth lens support frame according to the first example embodiment.

FIG. 5 is a developed view of an inner surface of a drive barrel according to the first example embodiment.

FIG. 6 is a sectional view illustrating a relationship between depths of drive transmission grooves (straight grooves) at intersecting portions where the drive transmission grooves (straight grooves) and the cam grooves intersect with each other according to the first example embodiment.

FIG. 7 is a perspective view illustrating an engagement state of the drive barrel according to the first example embodiment.

FIG. 8 is a developed view of the inner surface of the drive barrel at timing when drive shafts according to the first example embodiment cross intersecting portions.

FIG. 9 is a sectional view illustrating a relationship between an intersecting portion and a drive shaft after completion of engagement of the drive barrel according to the first example embodiment.

FIGS. 10A and 10B are sectional views each illustrating a depth of a drive transmission groove (straight groove) and a depth of a cam groove at an intersecting portion where the drive transmission groove (straight groove) and the cam groove intersect with each other according to a second example embodiment.

FIGS. 11A and 11B are sectional views each illustrating an amount of engagement between a cam groove and a cam shaft at an intersecting portion between the drive transmission groove (straight groove) and the cam groove which are disposed at positions where the drive transmission groove and a gear portion are opposed to each other on inner and outer surfaces according to the second example embodiment.

FIGS. 12A and 12B are sectional views each illustrating an amount of engagement between a cam groove and a cam shaft at an intersecting portion between the drive transmission groove (straight groove) and the cam groove which are disposed at positions where the drive transmission groove and the gear portion are not opposed to each other on the inner and outer surfaces according to the second example embodiment.

FIGS. 13A to 13C are sectional views each illustrating the depth of the drive transmission groove (straight groove) and the depth of the cam groove at the intersecting portion where the drive transmission groove (straight groove) and the cam groove intersect with each other according to the second example embodiment.

FIGS. 14A and 14B are sectional views each illustrating an amount of engagement between a cam groove and a cam shaft at the intersecting portion between the drive transmission groove (straight groove) and the cam groove which are disposed at positions where the drive transmission groove and the gear portion are opposed to each other on the inner and outer surfaces according to the second example embodiment.

FIGS. 15A and 15B are external views each illustrating an image capturing apparatus on which a lens barrel illustrated in FIGS. 1 and 3 are mounted.

### DESCRIPTION OF THE EMBODIMENTS

### First Example Embodiment

### (Example Components Supported by Rotation Barrel)

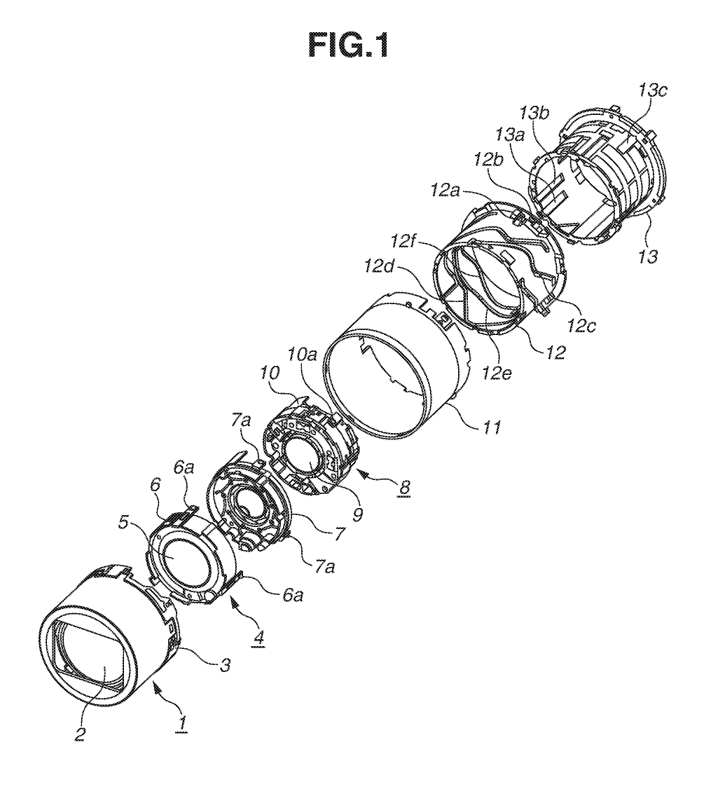

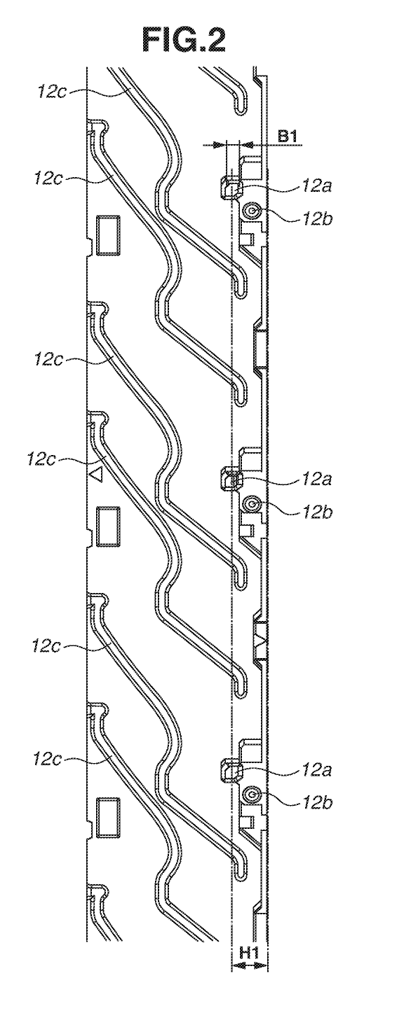

A lens barrel according to a first example embodiment of the disclosure will be described with reference to the drawings. Components that are supported by a rotation barrel will be described with reference to FIGS. 1 and 2.

FIG. 1 is an exploded perspective view illustrating components that are supported by the rotation barrel (second barrel) of a lens barrel.

FIG. 2 is a developed view of an outer surface of the rotation barrel having a structure in which drive shafts, cam shafts (cam pins), and cam grooves are formed on an outer peripheral surface of the rotation barrel.

As illustrated in FIGS. 1 and 2, the lens barrel includes a first lens unit 1, a second lens unit 4, an aperture unit 7, a third lens unit 8, a cover barrel 11, a rotation barrel 12 (rotary member), and a straight barrel 13.

The first lens unit 1 includes at least a first lens 2 and a first lens support frame 3 that supports the first lens 2. On the first lens support frame 3, six cam shafts (not illustrated) which extend along an inner circumferential direction are provided at regular intervals of 60 degrees and engage with cam grooves 12c of the rotation barrel 12 to be described below.

The second lens unit 4 includes at least a second lens 5 and a second lens support frame 6 that supports the second lens 5. On each second lens support frame 6, three cam shafts (cam pin) 6a which extend along an outer circumferential direction are formed at regular intervals of 120 degrees.

The cam shafts 6a penetrate through straight holes 13a of the straight barrel 13 to be described below and engage with cam grooves 12d of the rotation barrel 12 to be described below. The aperture unit 7 is provided with three cam shafts (cam pin) 7a which extend along the outer circumferential direction and are formed at regular intervals of 120 degrees. The cam shafts 7a penetrate through straight holes 13b of the straight barrel 13 to be described below and engage with cam grooves 12e of the rotation barrel 12 to be described below.

The third lens unit 8 includes at least a third lens 9 and a third lens support frame 10 that supports the third lens 9. The third lens support frame 10 is provided with three cam shafts (cam pins) 10a which extend along the outer circumferential direction and are formed at regular intervals of 120 degrees. The cam shafts 10a penetrate through straight holes 13c of the straight barrel 13 to be described below and engage with cam grooves 12f of the rotation barrel 12 to be described below.

The cover barrel 11 is disposed on the outer periphery of the first lens unit 1 and is fixed to the rotation barrel 12 to be described below. The rotation barrel 12 (rotary member) is disposed on the outer periphery of the straight barrel 13 and rotatably engages with the straight barrel 13. On the outer peripheral surface of the rotation barrel 12, three drive shafts 12a (straight pins/engagement pins) extending along the outer circumferential direction are formed at regular intervals of 120 degrees, at an equal height H1 in an optical axis direction, and with an equal length extending along the outer circumferential direction (FIG. 2).

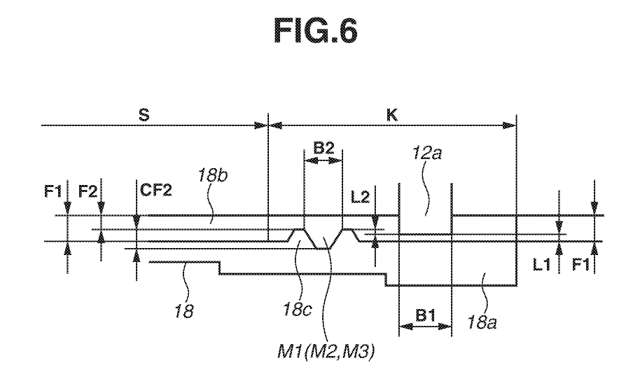

The three drive shafts 12a are movable in the optical axis direction. Accordingly, if the three drive shafts 12a are formed at different heights in the optical axis direction, the lengths in the optical axis direction of drive transmission grooves 18b of a drive barrel 18 to be described below need to be different, which leads to an increase in the overall length of the lens barrel. Therefore, the drive shafts 12a are formed at the same height H1 in the optical axis direction. A width B1 of each drive shaft 12a in the optical axis direction is set to be greater than a width B2 of each cam groove 18c in the optical axis direction at the position of each intersecting portion (M1, M2, and M3) of the drive barrel 18 to be described below (FIG. 6).

The drive shafts (straight pins) 12a penetrate through cam holes 17b of a fixed barrel 17. The drive shafts 12a engage with the drive transmission grooves (straight grooves) 18b of the drive barrel 18, and a driving force from the drive barrel 18 is transmitted to the drive shafts (straight pins) 12a, thereby enabling the rotation barrel 12 to rotate while being in contact with the outer periphery of the straight barrel 13. Three cam shafts (cam pins) 12b extending along the outer circumferential direction are formed at regular intervals of 120 degrees and engage with cam grooves 17c of the fixed barrel 17 to be described below.

Six cam grooves 12c which engage with six cam shafts (not illustrated) of the first lens support frame 3 and cause the first lens unit 1 to move along the optical axis direction are formed at regular intervals of 60 degrees. Three cam grooves 12d which engage with three cam shafts 6a of the second lens support frame 6 and cause the second lens unit 4 to move along the optical axis direction are formed at regular intervals of 120 degrees on an inner peripheral surface of the rotation barrel 12. Three cam grooves 12e which engage with three cam shafts 7a of the aperture unit 7 and cause the aperture unit 7 to move along the optical axis direction are formed at regular intervals of 120 degrees. Three cam grooves 12f which engage with three cam shafts 10a of the third lens support frame 10 and cause the third lens unit 8 to move along the optical axis direction are formed at regular intervals of 120 degrees.

The straight barrel 13 is provided with three straight holes 13a which engage with three cam shafts 6a of the second lens support frame 6 and guide the second lens unit 4 along the optical axis direction. The three straight holes 13a are formed at regular intervals of 120 degrees. The straight barrel 13 is further provided with three straight holes 13b which engage with three cam shafts 7a of the aperture unit 7 and guide the aperture unit 7 along the optical axis direction. The three straight holes 13b are formed at regular intervals of 120 degrees. The straight barrel 13 is further provided with three straight holes 13c which engage with three cam shafts 10a of the third lens support frame 10 and guide the third lens unit 8 along the optical axis direction. The three straight holes 13c are formed at regular intervals of 120 degrees.

### (Example Components Supported by Fixed Barrel)

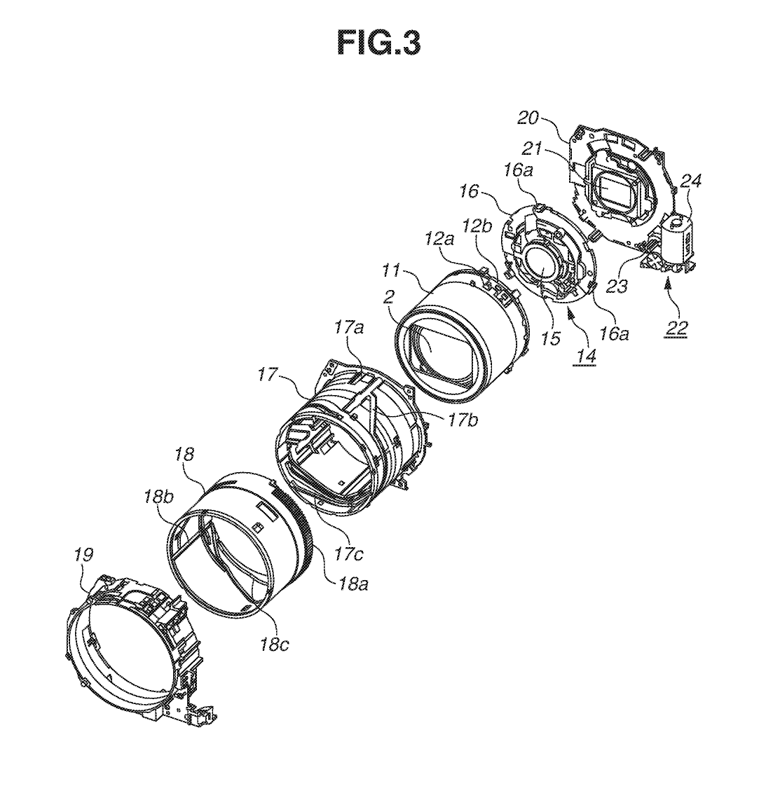

Components that are supported by the fixed barrel 17 will be described with reference to FIGS. 3 to 6.

FIG. 3 is an exploded perspective view of the lens barrel illustrating the components supported by the fixed barrel 17.

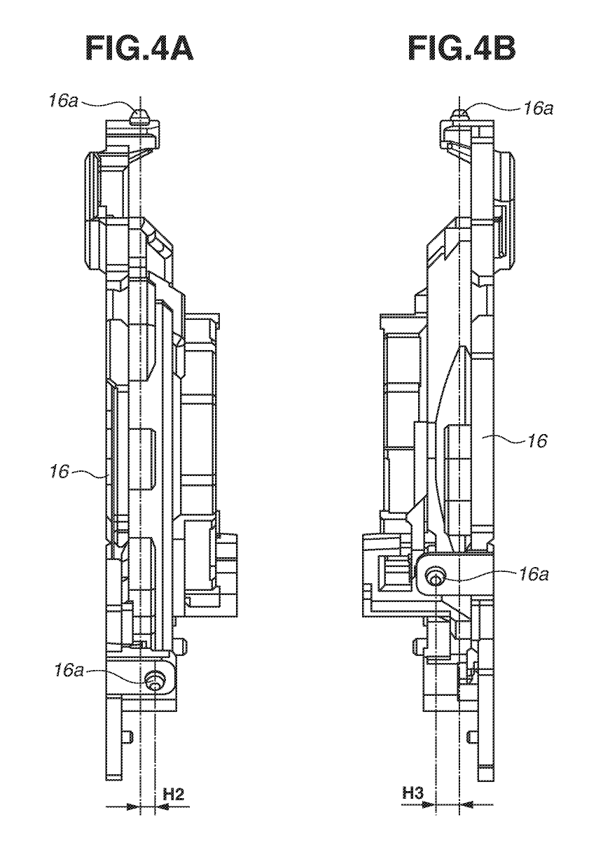

FIG. 4A is a left side view of a fourth lens support frame. FIG. 4B is a right side view of the fourth lens support frame.

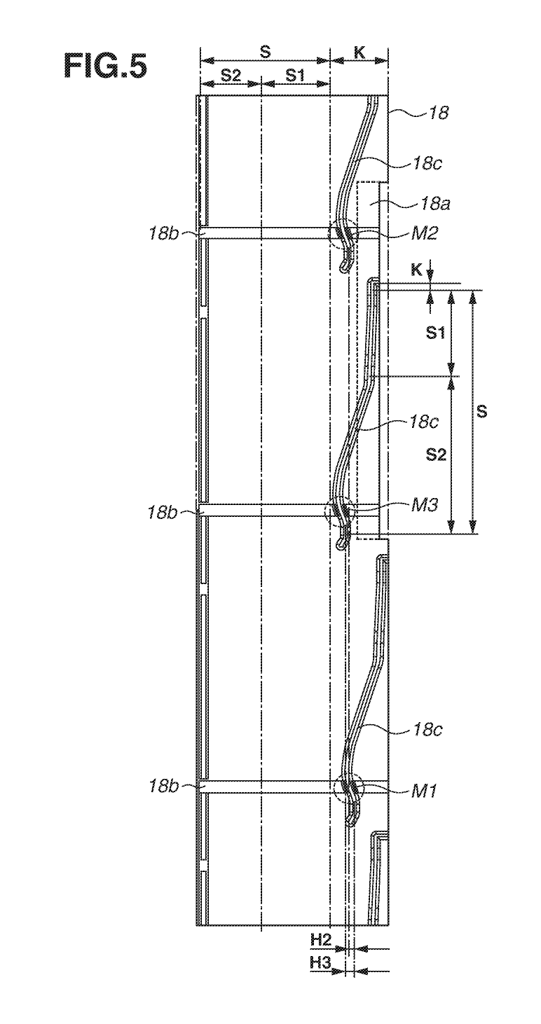

FIG. 5 is a developed view of an inner surface of the drive barrel having a structure in which cam grooves and straight grooves are formed on the inner peripheral surface of the drive barrel.

FIG. 6 is a sectional view illustrating a relationship between depths of drive transmission grooves at intersecting portions where the drive transmission grooves and cam grooves intersect with each other.

As illustrated in FIGS. 3 to 6, the lens barrel includes a fourth lens unit 14, the fixed barrel 17 (fixed member), the drive barrel 18 (barrel member), a cover barrel 19, a fixing base plate 20, and a drive unit 22. The fourth lens unit 14 includes at least a fourth lens 15 and a fourth lens support frame 16 that supports the fourth lens 15.

As illustrated in FIGS. 4A and 4B, the fourth lens support frame 16 is provided with three cam shafts 16a which extend along the outer circumferential direction and are formed at regular intervals of 120 degrees and at different heights H2 and H3 in the optical axis direction. The cam shafts 16a penetrate through straight holes 17a of the fixed barrel 17 to be described below and engage with the cam grooves 18c of the drive barrel 18 to be described below.

The fixed barrel 17 (fixed member) is fixed to the fixing base plate 20. The fixed barrel 17 is provided with three straight holes 17a which engage with three cam shafts 16a of the fourth lens support frame 16 and guide the fourth lens unit 14 along the optical axis direction. The three straight holes 17a are formed at regular intervals of 120 degrees. The fixed barrel 17 is further provided with three cam holes 17b through which the three drive shafts 12a of the rotation barrel 12 penetrate. The three cam holes 17b are formed at regular intervals of 120 degrees. The fixed barrel 17 is further provided with three cam grooves 17c which engage with the three cam shafts (cam pins) 12b of the rotation barrel 12 and cause the rotation barrel 12 to move along the optical axis direction. The three cam grooves 17c are formed at regular intervals of 120 degrees on an inner peripheral surface of the fixed barrel 17.

The drive barrel 18 (first barrel member) is disposed on the outer periphery of the fixed barrel 17 and rotatably engages with the fixed barrel 17. A gear portion 18a which engages with a gear train 23 to be described below is formed on the outer peripheral surface of the drive barrel 18, and a driving force from a motor 24 is transmitted to the gear portion 18a, thereby enabling the drive barrel 18 to rotate while being in contact with the outer periphery of the fixed barrel 17.

The drive barrel 18 is provided with three drive transmission grooves (straight grooves) 18b which engage with three drive shafts 12a of the rotation barrel (second barrel) 12 and transmit the driving force from the drive barrel 18 to the rotation barrel 12. The three drive transmission grooves 18b are formed at regular intervals of 120 degrees on the inner peripheral surface of the drive barrel 18.

Two of the three drive transmission grooves (straight grooves) 18b are disposed at positions where the drive transmission grooves 18b are opposed to the gear portion 18a on the inner and outer surfaces. Alternatively, one drive transmission groove 18b may be disposed at a position where the drive transmission groove 18b is opposed to the gear portion 18a on the inner and outer surfaces. Each drive transmission groove 18b includes an engagement area K which is used for engagement with the three drive shafts (straight pins) 12a of the rotation barrel 12, and an operation area S which is used for capturing an image with the three drive shafts 12a of the rotation barrel 12 and which includes a non-image-capturing operation area S1 and an image-capturing operation area S2. The image-capturing operation area S2 is an area in which image capturing is performed, and the non-image-capturing operation area S1 is an area in which image capturing is not performed.

As illustrated in FIG. 6, a depth of each of the three drive transmission grooves (straight grooves) 18b in the engagement area K includes a depth F1 and a depth F2. The depth F includes a gap L1 between a leading end of each of the three drive shafts 12a of the rotation barrel 12 and a bottom surface of each of the three drive transmission grooves 18b. The depth F2 includes an overlap amount L2 by which a leading end of each of the three cam grooves 18c overlaps the leading end of each of the three drive shafts 12a of the rotation barrel 12 at intersecting portions M1, M2, and M3 where the three drive transmission grooves 18b intersect with the three cam grooves 18c.

The three drive transmission grooves 18b are formed at the same depth F2, and the depth F2 is smaller than the depth F1. The overlap amount L2 includes an amount of backlash in the engagement between the fixed barrel 17 and the drive barrel 18 and an amount of deformation of the fixed barrel 17 and the drive barrel 18.

As illustrated in FIG. 6, the drive transmission groove 18b in the operation area S is formed at the depth F1 including the gap L between the leading end of each of the three drive shafts 12a of the rotation barrel 12 and the bottom surface of each of the three drive transmission grooves 18b (straight grooves). Three cam shafts 16a of the fourth lens support frame 16 engage with the fixed barrel 17.

The drive barrel 18 includes three cam grooves (a first cam groove, a second cam groove, and a third cam groove) 18c which cause the fourth lens unit 14 to move along the optical axis direction. The three cam grooves 18c are formed at regular intervals of 120 degrees and at different heights H2 and H3 in the optical axis direction. The different heights H2 and H3 are each greater than or equal to a width of the leading end of each of the three drive shafts 12a of the rotation barrel 12 that passes through the intersecting portions (M1, M2, and M3).

Each cam groove 18c includes the engagement area K which is used for engagement of the three cam shafts 16a, and the operation area S which is used for capturing an image with the three cam shafts 16a and which includes the non-image-capturing operation area S1 and the image-capturing operation area S2. The image-capturing operation areas S2 of the three cam grooves 18c intersect with each other in the engagement area K of the three drive transmission grooves 18b. Since the three cam grooves 18c are formed at different heights H2 and H3 in the optical axis direction, the intersecting portions M1, M2, and M3 are also formed at different heights H2 and H3. These intersecting portions enable the three cam grooves 18c to be disposed at positions irrespective of the drive transmission grooves 18b and enable the three cam grooves 18c to be gently inclined, which leads to a reduction in operation load.

As illustrated in FIG. 6, the three drive transmission grooves 18b at the intersecting portions M1, M2, and M3 are formed at the same depth F2, and the depth F2 is smaller than the depth F1. With this structure, a depth CF2 of the three cam grooves 18c is increased and a desired amount of engagement of the three cam shafts 16a of the fourth lens support frame 16 can be ensured. When the three cam shafts 16a of the fourth lens support frame 16 pass through the intersecting portions M1, M2, and M3, the three cam shafts 16a can be prevented from being disengaged from the three cam grooves 18c and from moving to the three drive transmission grooves 18b. The image-capturing operation areas S2 of the three cam grooves 18c can be disposed at the intersecting portions M1, M2, and M3.

The cover barrel 19 is disposed on the outer periphery of the drive barrel 18 and is fixed to the fixing base plate 20. The fixing base plate 20 fixes an image sensor 21 thereto and supports the drive unit 22. The drive unit 22 includes the gear train 23 and the motor 24. The gear train 23 rotatably engages with the fixing base plate 20 and is supported by the cover barrel 19.

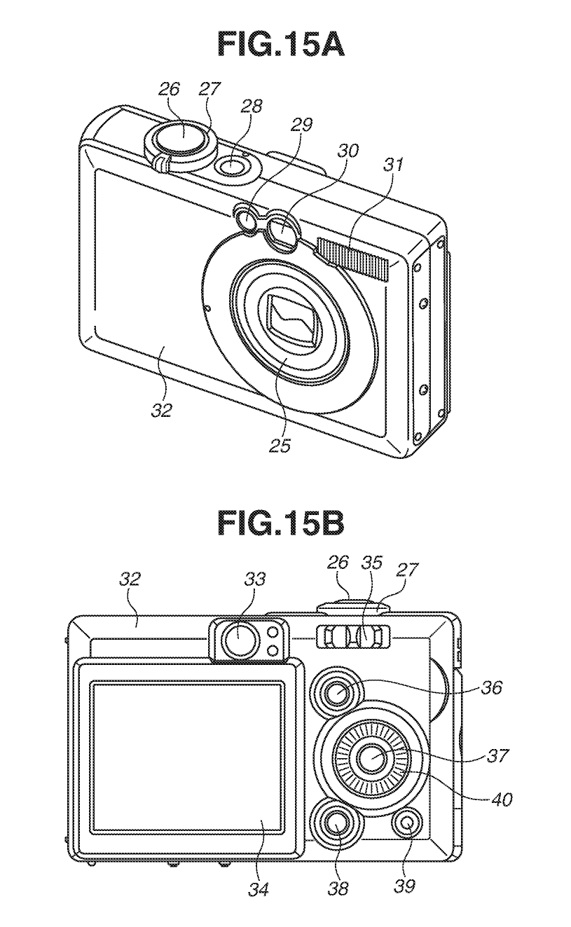

FIGS. 15A and 15B each illustrate an example of an appearance of an image capturing apparatus on which the lens barrel illustrated in FIGS. 1 and 3 is mounted. The image capturing apparatus is a compact digital camera of a retractable type in which the barrel retracts from a camera body.

FIG. 15A illustrates a front perspective view of a digital camera 32. FIG. 15B illustrates a rear view of the digital camera 32. The digital camera 32 is an example of the image capturing apparatus according to the present example embodiment. The digital camera 32 includes a zoom mechanism capable of changing an image capturing magnification.

On the front surface of the digital camera 32, a finder 30 which determines a composition of an object, an assist light 29 which assists a light source when photometry and ranging are performed, a flash unit 31, and an image capturing lens barrel 25 are provided. The image capturing lens barrel 25 is an example of the lens barrel according to the present example embodiment. On the upper surface of the digital camera 32, a release button 26, a zoom selection switch 27, and a power supply switch button 28 are disposed. On the rear surface of the digital camera 32, operation buttons 35, 36, 37, 38, 39, and 40, a display 34, and a finder eyepiece portion 33 are disposed.

Various functions can be switched by operating the operation buttons. The display 34 is, for example, a liquid crystal display (LCD). The display 34 displays image data stored in a memory (not illustrated) and image data read from a memory card on a screen. The finder eyepiece portion 33 is used for a user to determine a composition with his/her eyes, or to adjust a focus.

### (Example Engagement of Drive Barrel)

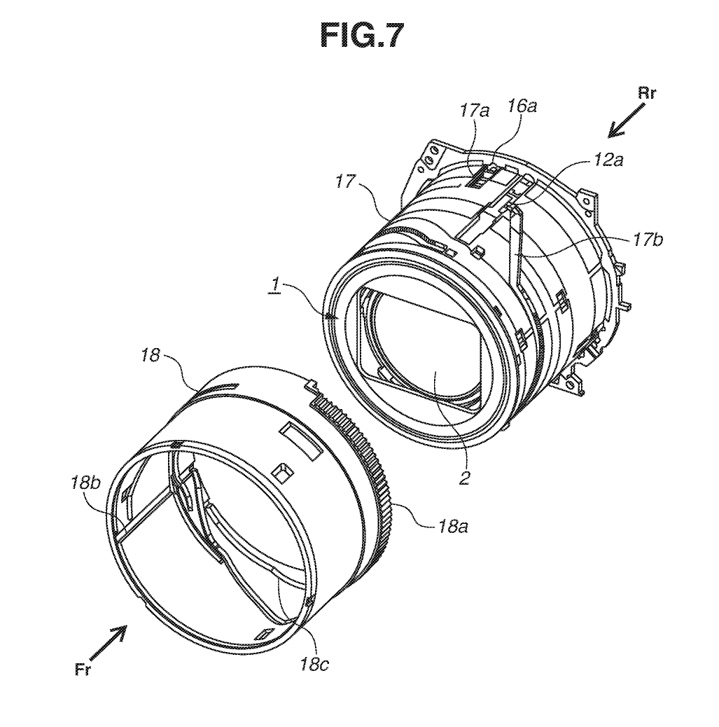

Next, the engagement of the drive barrel 18 will be described with reference to FIGS. 7 to 9.

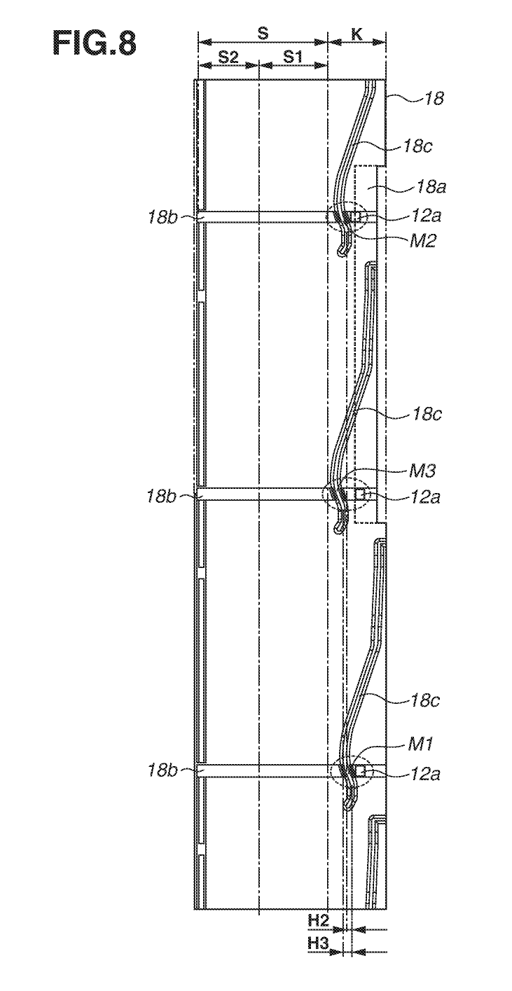

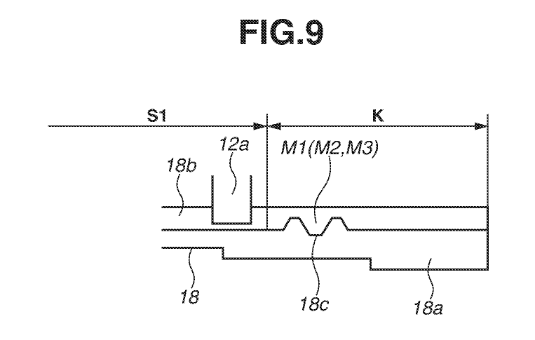

FIG. 7 is a perspective view illustrating an engagement state of the drive barrel 18. FIG. 8 is a developed view of the inner surface of the drive barrel 18 at timing when the drive shafts cross the intersecting portions. FIG. 9 is a sectional view illustrating a relationship between the intersecting portion and the drive shaft after completion of engagement of the drive barrel 18.

As illustrated in FIG. 7, the drive barrel (first barrel) 18 is inserted from an object side Fr toward an imaging plane side Rr. The insertion of the drive barrel 18 enables the engagement areas K of the three drive transmission grooves (straight grooves) 18b of the drive barrel 18 to pass through the three drive shafts 12a of the rotation barrel 12. After the engagement areas K of the three drive transmission grooves 18b pass through the three drive shafts 12a, the intersecting portions M1, M2, and M3 are formed at different heights at the positions where the three cam grooves 18c intersect with the three drive transmission grooves 18b.

Accordingly, as illustrated in FIG. 8, the three drive shafts 12a of the rotation barrel 12 cross the intersecting portions M1, M2, and M3 by the overlap amount L2 at timings corresponding to the intersecting portions M1, M2, and M3. The three drive shafts 12a of the rotation barrel (second barrel) 12 cross the intersecting portions M1, M2, and M3. In this case, since the width B1 in the optical axis direction of the drive shafts (straight pins) 12a is greater than the width B2 in the optical axis direction of the cam grooves 18c, the drive shafts 12a can pass through the intersecting portions without falling into the cam grooves 18c of the drive barrel 18.

The depth of each cam groove is greater than the depth of each straight groove. This is because if the depth of each cam groove is not greater than the depth of each straight groove, a sufficient driving force cannot be applied to the cam pins formed on each lens unit. The drive barrel 18 is deformed by an amount corresponding to the amount of backlash in the engagement between the fixed barrel 17 and the drive barrel 18 and the amount of deformation of the fixed barrel 17 and the drive barrel 18. This makes it possible to avoid a damage to the leading ends of the three drive shafts 12a of the rotation barrel 12 and the apex portions of the intersecting portions M1, M2, and M3.

Since the three drive shafts 12a of the rotation barrel 12 cross the intersecting portions M1, M2, and M3 at different timings, the overlap amount L2 to be set can be increased as compared with a case where the three drive shafts 12a of the rotation barrel 12 cross the intersecting portions M1, M2, and M3 at the same timing. An increase in the overlap amount L2 to be set enables the three cam grooves 18c to be formed at a greater depth, so that a desired amount of engagement of the three cam shafts (cam pins) 16a of the fourth lens support frame 16 can be ensured.

When the three drive shafts (straight pins) 12a of the rotation barrel 12 pass through the intersecting portions, the three drive shafts (straight pins) 12a can be prevented from being disengaged from the three cam grooves 18c and from moving to the three drive transmission grooves 18b. After the three drive shafts 12a cross the intersecting portions, as illustrated in FIG. 9, the three drive shafts 12a of the rotation barrel 12 reach the positions corresponding to the non-image-capturing operation areas S1 of the three drive transmission grooves 18b of the drive barrel 18, and thus the engagement of the drive barrel 18 is completed.

Timing when the first straight pin 12a passes through the first intersecting portion M1, timing when the second straight pin 12a passes through the second intersecting portion M2, and timing when the third straight pin 12a passes through the third intersecting portion M3 are different from each other. Accordingly, the position in the optical axis direction of the first cam groove 18c located at the first intersecting portion M1, the position in the optical axis direction of the second cam groove 18c located at the second intersecting portion M2, and the position in the optical axis direction of the third cam groove 18c located at the third intersecting portion M3 are different from each other.

Timing when a first cam pin passes through the first intersecting portion M1, timing when a second cam pin passes through the second intersecting portion M2, and timing when a third cam pin passes through the third intersecting portion M3 are the same as each other. Accordingly, the position in the optical axis direction of the first cam pin formed on the second barrel 12 is different from the position in the optical axis direction of the second cam pin formed on the second barrel.

The depth of the first straight groove 18b at the intersecting portion M1 is smaller than the depth of the first straight groove 18b at a portion other than intersecting portion (F1, F2). The depth of the second straight groove 18b at the intersecting portion M2 is smaller than the depth of the second straight groove 18b at a portion other than the intersecting portion (F1, F2). The width B1 in the optical axis direction of the first straight pin 12a at the intersecting portion M1 is greater than the width B2 in the optical axis direction of the first cam groove 18c at the intersecting portion M1. The width B1 in the optical axis direction of the second straight pin 12a at the intersecting portion M2 is greater than the width B2 in the optical axis direction of the second cam groove 18c at the intersecting portion M2.

The intersecting portion M2 is an intersecting portion of the second straight groove 18b formed on the inside of an area in which the gear portion 18a, which is formed on the outer periphery of the drive barrel (first barrel) 18, is present in the circumferential direction. In this case, the depth of the second straight groove 18b at the intersecting portion M2 is greater than the depth at the intersecting portion M1 of the first straight groove 18b formed on the inside of an area in which the gear portion 18a, which is formed at the outer periphery of the drive barrel (first barrel) 18, is not present in the circumferential direction.

The first intersecting portion M1 is formed in the engagement area K in which the first straight pin 12a is engaged with the first straight groove 18b. The second intersecting portion M2 is formed in the engagement area K in which the second straight pin 12a is engaged with the second straight groove 18b. The position in the optical axis direction of the first straight pin 12a formed on the second barrel 12 is the same as the position in the optical axis direction of the second straight pin 12a formed on the second barrel 12.

### Second Example Embodiment

A second example embodiment of the disclosure will be described with reference to the drawings.

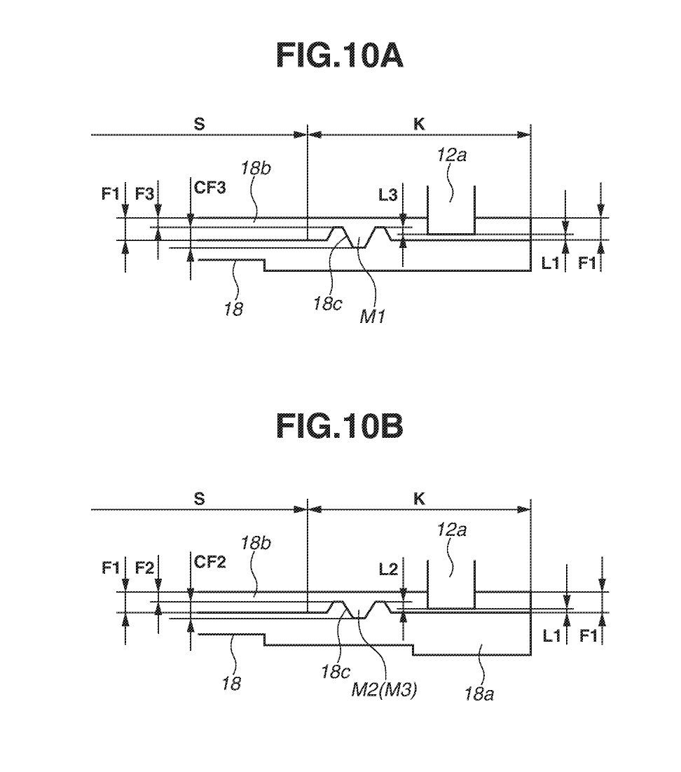

FIG. 10A is a sectional view illustrating a depth of a drive transmission groove and a depth of a cam groove at an intersecting portion between the drive transmission groove and the cam groove which are disposed at positions where the drive transmission groove and the gear portion are opposed to each other on the inner and outer surfaces, like in FIG. 6.

FIG. 10B is a sectional view illustrating a depth of a drive transmission groove and a depth of a cam groove at an intersecting portion between the drive transmission groove and the cam groove which are disposed at positions where the drive transmission groove and the gear portion are not opposed to each other on the inner and outer surfaces.

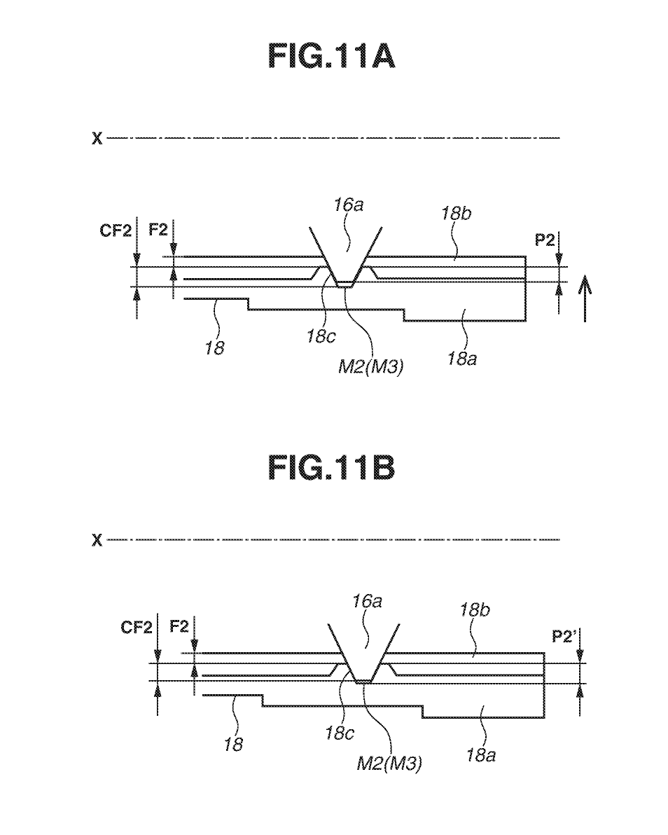

FIG. 11A is a sectional view illustrating an amount of engagement between a cam groove and a cam shaft, which are disposed at positions where the drive transmission groove and the gear portion are opposed to each other on the inner and outer surfaces, and also illustrating a state where a driving force from a motor is not transmitted to a drive barrel.

FIG. 11B is a sectional view illustrating the amount of engagement between the cam groove and the cam shaft, which are disposed at positions where the drive transmission groove and the gear portion are opposed to each other on the inner and outer surfaces, and also illustrating a state where the driving force from the motor is transmitted to the drive barrel.

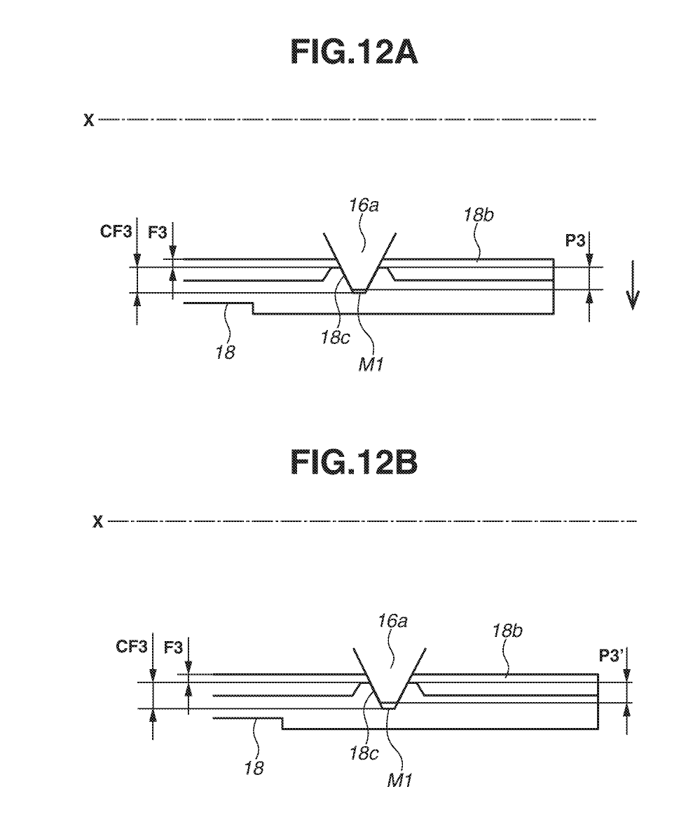

FIG. 12A is a sectional view illustrating the amount of engagement between the cam groove and the cam shaft, which are disposed at positions where the drive transmission groove and the gear portion are not opposed to each other on the inner and outer surfaces, and also illustrating a state where the driving force from the motor is not transmitted to the drive barrel.

FIG. 12B is a sectional view illustrating the amount of engagement between the cam groove and the cam shaft, which are disposed at positions where the drive transmission groove and the gear portion are not opposed to each other on the inner and outer surfaces, and also illustrating a state where the driving force from the motor is transmitted to the drive barrel.

An example mechanical structure according to the second example embodiment is substantially similar to the mechanical structure according to the first example embodiment. Accordingly, components of the second example embodiment which are identical to the components according to the first example embodiment illustrated in FIGS. 1 to 9 are denoted by the same reference numerals in FIGS. 10 to 12, and thus descriptions of the components are omitted. An engagement according to the second example embodiment of the disclosure is also identical to the engagement according to the first example embodiment described above, and thus descriptions thereof are omitted.

Components of the second example embodiment that are different from those according to the first example embodiment will be described below.

The intersecting portion M is an intersecting portion between one drive transmission groove 18b and one cam groove 18c which are disposed at positions where the drive transmission groove 18b and the gear portion 18a are not opposed to each other on the inner and outer surfaces. At the intersecting portion M1, a depth F3 including an overlap amount L3 by which the leading end of one drive shaft 12a of the rotation barrel 12 overlaps the leading end of one cam groove 18c is set as illustrated in FIG. 10A.

The depth F3 of one drive transmission groove 18b is set to be smaller than the depth F2 of two drive transmission grooves 18b at the intersecting portions M2 and M3 between two drive transmission grooves 18b and two cam grooves 18c which are disposed at positions where the drive transmission groove 18b and the gear portion 18a are opposed to each other on the inner and outer surfaces as illustrated in FIG. 10B. In other words, a depth CF3 of the cam groove 18c at the intersecting portion M1 illustrated in FIG. 10A is set to be greater than the depth CF2 of the cam groove 18c at the intersecting portions M2 and M3 illustrated in FIG. 10B. With this structure, when the driving force from the motor 24 is transmitted to the drive barrel 18, a backlash in the engagement between the fixed barrel 17 and the drive barrel 18 and deformation of the fixed barrel 17 and the drive barrel 18 are generated.

Due to the deformation, the intersecting portions M2 and M3 which are disposed at positions where the intersecting portions M2 and M3 are opposed to the gear portion 18a on the inner and outer surfaces move in the direction toward an image capturing optical axis X as illustrated in FIGS. 11A and 11B. Due to the movement, an engagement amount P2 between two cam shafts 16a of the fourth lens support frame 16 and two cam grooves 18c of the drive barrel 18 as illustrated in FIG. 11A is changed to an engagement amount P2′ illustrated in FIG. 11B. Specifically, when the driving force from the motor 24 is transmitted to the drive barrel 18, the amount of engagement between two cam shafts 16a of the fourth lens support frame 16 and two cam grooves 18 of the drive barrel 18 at the intersecting portions M2 and M3 increases.

Like in the first example embodiment, a desired amount of engagement between the cam shafts 16a of the fourth lens support frame 16 and the cam grooves 18c of the drive barrel 18 can be ensured. The intersecting portion M1 disposed at a position where the intersecting portion M is not opposed to the gear portion 18a on the inner and outer surfaces moves in a direction away from the image capturing optical axis X as illustrated in FIGS. 12A and 12B.

Due to the movement, an engagement amount P3 between one cam shaft 16a of the fourth lens support frame 16 and one cam groove 18c of the drive barrel 18 as illustrated in FIG. 12A is changed to an engagement amount P3′ illustrated in FIG. 12B. Specifically, when the driving force from the motor 24 is transmitted to the drive barrel 18, the amount of engagement between one cam shaft 16a of the fourth lens support frame 16 and one cam groove 18c of the drive barrel 18 at the intersecting portion M1 decreases.

While the engagement amount decreases from P3 to P3′, the depth CF3 of the cam groove 18c at the intersecting portion M1 illustrated in FIG. 10B is set to be greater than the depth CF2 of the cam groove 18c at the intersecting portions M2 and M3 illustrated in FIG. 10A. Accordingly, when the driving force from the motor 24 is transmitted to the drive barrel 18, a larger amount of engagement between the cam shaft 16a of the fourth lens support frame 16 and the cam groove 18c of the drive barrel 18 can be obtained than that in the first example embodiment.

### Third Example Embodiment

A third example embodiment of the disclosure will be described with reference to the drawings.

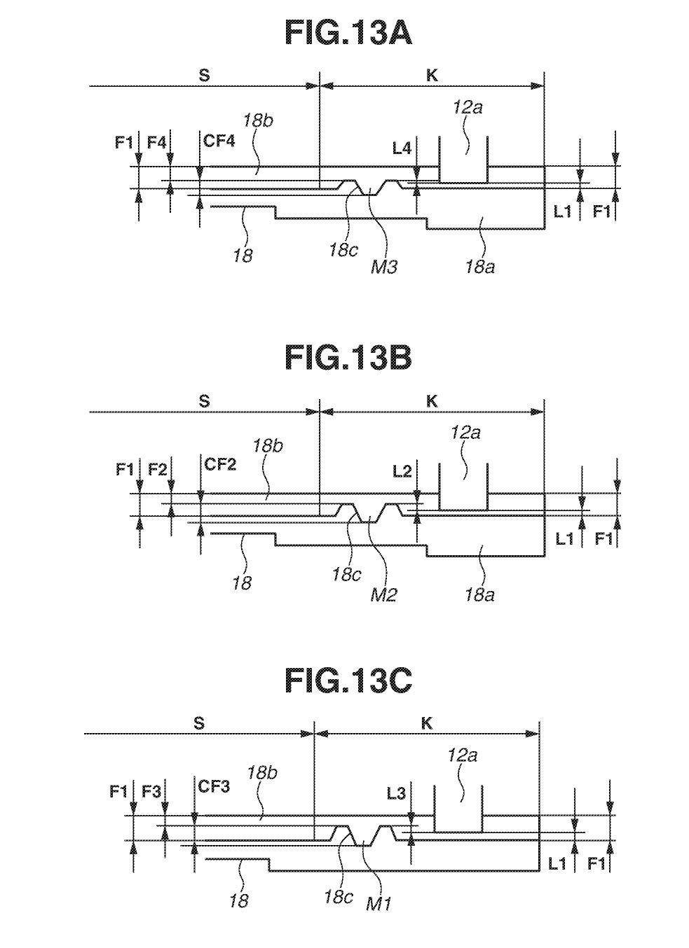

FIG. 13A is a sectional view illustrating a depth of a drive transmission groove and a depth of a cam groove at an intersecting portion between the drive transmission groove and the cam groove which are disposed at positions where the drive transmission groove and the gear portion are opposed to each other on the inner and outer surfaces.

FIG. 13B is a sectional view illustrating the depth of the transmission groove and the depth of the cam groove at the intersecting portion between the drive transmission groove and the cam groove which are disposed at positions where the drive transmission groove and the gear portion are opposed to each other on the inner and outer surfaces, like in FIG. 10B.

FIG. 13C is a sectional view illustrating the depth of the transmission groove and the depth of the cam groove at the intersecting portion between the drive transmission groove and the cam groove which are disposed at positions where the drive transmission groove and the gear portion are not opposed to each other on the inner and outer surfaces, like in FIG. 10A.

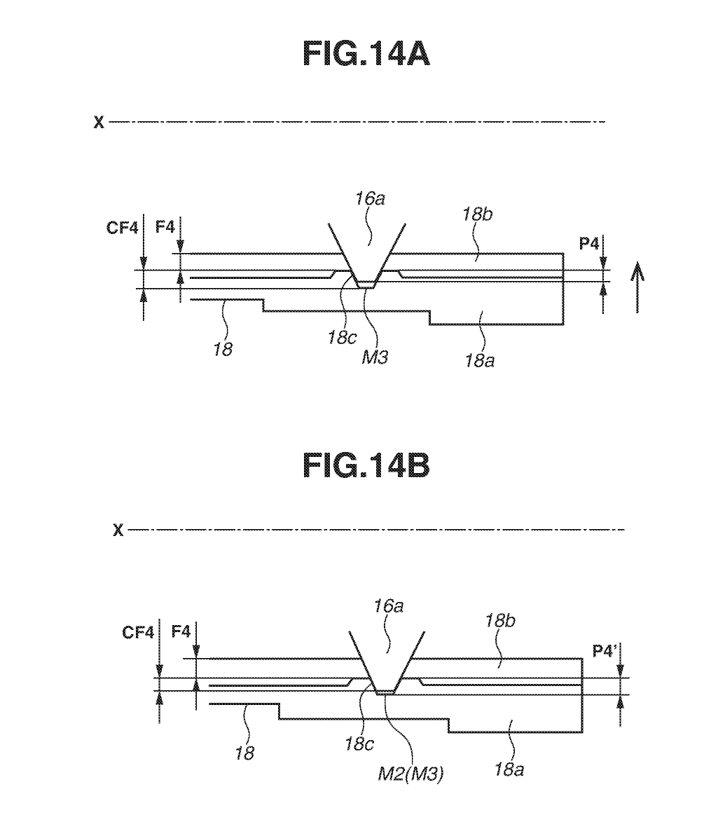

FIG. 14A is a sectional view illustrating the amount of engagement between the cam groove and the cam shaft which are disposed at positions where the drive transmission groove and the gear portion are opposed to each other on the inner and outer surfaces, and also illustrating a state where the driving force from the motor is not transmitted to a drive barrel.

FIG. 14B is a sectional view illustrating the amount of engagement between the cam groove and the cam shaft which are disposed at positions where the drive transmission groove and the gear portion are opposed to each other on the inner and outer surfaces, and also illustrating a state where the driving force from the motor is transmitted to the drive barrel.

A mechanical structure according to the third example embodiment is substantially similar to the mechanical structure according to the second example embodiment. Accordingly, components of the third example embodiment which are identical to the components according to the second example embodiment illustrated in FIGS. 10 to 12 are denoted by the same reference numerals in FIGS. 14 and 15, and thus descriptions of the components are omitted. An engagement according to the third example embodiment of the disclosure is also substantially similar to the engagement according to the first and second example embodiments described above, and thus descriptions thereof are omitted.

Components of the third example embodiment that are different from those according to the second example embodiment will be described below.

The intersecting portion M3 is an intersecting portion between one drive transmission groove 18b and one cam groove 18c which are disposed at positions where the drive transmission groove 18b and the gear portion 18a are opposed to each other on the inner and outer surfaces. As illustrated in FIG. 13A, a depth F4 including an overlap amount LA by which the leading end of one drive shaft 12a of the rotation barrel 12 overlaps the leading end of one cam groove 18c at the intersecting portion M3 is set.

The depth F4 of one drive transmission groove 18b is set to be greater than the depth F2 of one drive transmission groove 18b at the intersecting portion M2 between one drive transmission groove 18b and one cam groove 18c which are disposed at positions where the drive transmission groove 18b and the gear portion 18a are opposed to each other on the inner and outer surfaces as illustrated in FIG. 13B. In other words, a depth CF4 of the cam groove 18c at the intersecting portion M3 illustrated in FIG. 13A is set to be smaller than the depth CF2 of the cam groove 18c at the intersecting portion M2 illustrated in FIG. 13B. With this structure, when the driving force from the motor 24 is transmitted to the drive barrel 18, a backlash in the engagement between the fixed barrel 17 and the drive barrel 18 and deformation of the fixed barrel 17 and the drive barrel 18 are generated.

Due to the deformation, the intersecting portion M3 disposed at a position where the intersecting portion M3 and the gear portion 18a are opposed to each other on the inner and outer surfaces moves in the direction toward the image capturing optical axis X as illustrated in FIGS. 14A and 14B. Due to the movement, an engagement amount P4 between one cam shaft 16a of the fourth lens support frame 16 and one cam groove 18c of the drive barrel 18 illustrated in FIG. 14A is changed to an engagement amount P4′ illustrated in FIG. 14B. Specifically, when the driving force from the motor 24 is transmitted to the drive barrel 18, the amount of engagement between one cam shaft 16a of the fourth lens support frame 16 and one cam groove 18c of the drive barrel 18 at the intersecting portion M3 increases.

When the driving force from the motor 24 is transmitted to the drive barrel 18, a desired amount of engagement between the cam shaft 16a of the fourth lens support frame 16 and the cam groove 18c of the drive barrel 18 can be ensured, like in the first example embodiment.

The depth F4 of the drive transmission groove at the intersecting portion M3 is set to be greater than the depth F2 of the drive transmission groove at the intersecting portion M2, and the depth F3 of the drive transmission groove at the intersecting portion M1 is set to be smaller than the depth F2 of the drive transmission groove at the intersecting portion M2. Accordingly, since the overlap amounts L2, L3, and L4 between the leading end of each drive shaft 12a of the rotation barrel 12 and the leading end of each cam groove 18c are different from each other, the engagement operability of the drive barrel 18 can be further improved than that in the first and second example embodiments.

The drive barrel (first barrel) 18 is provided with the third cam groove 18c, the third straight groove 18b extending along the optical axis direction, and the third intersecting portion M3 at which the third cam groove 18c and the third straight groove 18b intersect with each other. The third cam groove 18c, the third straight groove 18b, and the third intersecting portion M3 are formed on the inner peripheral surface of the drive barrel 18.

The first straight groove, the second straight groove, and the third straight groove have different depths. It is possible to increase a depth of a cam groove at an intersecting portion where the cam groove and a straight groove intersect with each other and to ensure a desired amount of engagement of each cam shaft, while preventing an increase in the size of the lens barrel and deterioration in engagement operability.

While the disclosure has been described with reference to example embodiments, it is to be understood that the invention is not limited to the disclosed example embodiments. The scope of the following claims is to be accorded the broadest interpretation so as to encompass all such modifications and equivalent structures and functions.

This application claims the benefit of Japanese Patent Application No. 2018-035317, filed Feb. 28, 2018, which is hereby incorporated by reference herein in its entirety.

What is claimed is:

1. A lens barrel comprising:
a first barrel including a first cam groove, a second cam groove, a first straight groove extending along an optical axis direction, and a second straight groove extending along the optical axis direction, the first cam groove, the second cam groove, the first straight groove, and the second straight groove being formed on a same plane of the first barrel;
a first cam pin configured to engage with the first cam groove;
a second cam pin configured to engage with the second cam groove;
a first straight pin configured to engage with the first straight groove; and
a second straight pin configured to engage with the second straight groove,
wherein the first barrel is provided with a first intersecting portion where the first cam groove intersects with the first straight groove, and a second intersecting portion where the second cam groove intersects with the second straight groove,
wherein a depth of the first straight groove at the first intersecting portion is smaller than a depth of the first straight groove at a portion other than the first intersecting portion,
wherein a depth of the second straight groove at the second intersecting portion is smaller than a depth of the second straight groove at a portion other than the second intersecting portion, and
wherein timing when the first straight pin configured to engage with the first straight groove passes through the first intersecting portion is different from timing when the second straight pin configured to engage with the second straight groove passes through the second intersecting portion.

2. The lens barrel according to claim 1,
wherein the depth of the first straight groove at the first intersecting portion is smaller than the depth of the first straight groove at the portion other than the first intersecting portion, and
wherein the depth of the second straight groove at the second intersecting portion is smaller than the depth of the second straight groove at a portion other than the second intersecting portion.

3. The lens barrel according to claim 1,
wherein a width of the first straight pin in the optical axis direction at the first intersecting portion is greater than a width of the first cam groove in the optical axis direction at the first intersecting portion, and
wherein a width of the second straight pin in the optical axis direction at the second intersecting portion is greater than a width of the second cam groove in the optical axis direction at the second intersecting portion.

4. The lens barrel according to claim 1, wherein the depth at the second intersecting portion of the second straight groove formed on an inside of an area in which a gear portion formed at an outer periphery of the first barrel is present is greater than the depth at the first intersecting portion of the first straight groove formed on an inside of an area in which the gear portion formed at the outer periphery of the first barrel is not present.

5. The lens barrel according to claim 1,
wherein the first intersecting portion is formed in an engagement area in which the first straight pin is engaged with the first straight groove, and
wherein the second intersecting portion is formed in an engagement area in which the second straight pin is engaged with the second straight groove.

6. The lens barrel according to claim 1, wherein a position in the optical axis direction of the first cam pin formed in a lens holding member and a position in the optical axis direction of the second cam pin formed in the lens holding member are set to be different from each other so that timing when the first cam pin passes through the first intersecting portion is same as timing when the second cam pin passes through the second intersecting portion.

7. The lens barrel according to claim 1,
wherein the first barrel is provided with a third cam groove, a third straight groove extending along the optical axis direction, and a third intersecting portion where the third cam groove intersects with the third cam groove, the third cam groove, the third straight groove, and the third intersecting portion being formed on an inner peripheral surface of the first barrel, and
wherein the first straight groove, the second straight groove, and the third straight groove have different depths.

8. The lens barrel according to claim 1, wherein a position in the optical axis direction of the first straight pin formed in a second barrel is same as a position in the optical axis direction of the second straight pin formed in the second barrel.

9. The lens barrel according to claim 1, wherein the depth of the first cam groove at the first intersecting portion is greater than the depth of the first straight groove at the first intersecting portion, and the depth of the second cam groove at the second intersecting portion is greater than the depth of the second straight groove at the second intersecting portion.

10. The lens barrel according to claim 1, wherein a position in the optical axis direction of the first cam groove located at the first intersecting portion is different from a position in the optical axis direction of the second cam groove located at the second intersecting portion.
